(19) United States
(12) Patent Application Publication
(10) Pub. No.: US 2017/0240780 A1
(43) Pub. Date: Aug. 24, 2017

(54) HYDROXY SILANE AS AN ADHESION PROMOTER OR CROSS-LINKING AGENT

(71) Applicant: SIKA TECHNOLOGY AG, Baar (CH)

(72) Inventors: Andreas KRAMER, Zürich (CH); Urs BURCKHARDT, Zürich (CH)

(73) Assignee: SIKA TECHNOLOGY AG, Baar (CH)

(21) Appl. No.: 15/519,513

(22) PCT Filed: Nov. 23, 2015
(86) PCT No.: PCT/EP2015/077375

§ 371 Date: Apr. 14, 2017

(30) Foreign Application Priority Data
Nov. 24, 2014 (EP) 14194597.2

(51) Int. Cl. C09J 11/06; C07F 7/18; C09D 7/12

(52) U.S. Cl. CPC C09J 11/06; C09D 7/1233; C07F 7/1868; C08K 5/5419

(57) ABSTRACT

A hydroxy silane of formula (I) used as an adhesion promoter or cross-linking agent for adhesives, sealants or coatings. The invention also relates to an adhesion-promoter composition containing the hydroxy silane of formula (I) and to adhesives, sealants or coatings containing the hydroxy silane of formula (I). The hydroxy silane of formula (I) has a surprisingly long shelf-life and exhibits an excellent action as an adhesion promoter and/or cross-linking agent.

### TECHNICAL FIELD

The invention relates to hydroxysilanes and to the use thereof as adhesion promoter or crosslinker for adhesives or sealants or coatings.

### STATE OF THE ART

Organosilanes having an additional functional group are often used in sealants, adhesives, coatings and pretreatment compositions such as primers or adhesion promoter solutions. They serve here as adhesion promoters or crosslinkers.

Typical organosilanes which are used as adhesion promoters or crosslinkers are mercaptosilanes or aminosilanes. However, these have disadvantages. Mercaptosilanes have an unpleasant odor and, with isocyanates, form thiourethanes that are not very thermally stable and are readily redissociatable at elevated temperature. Aminosilanes are basic and very reactive, which limits the use thereof as adhesion promoters.

There is little knowledge of hydroxysilanes from the prior art. The handling thereof has the difficulty that they have a tendency to self-condensation owing to a rapid reaction of the hydroxyl group with the silane group and are therefore frequently very impure and/or have a short shelf life. However, they would be of interest as adhesion promoters and crosslinkers since their reactivity is not quite as high, which often improves the adhesion promoter effect. Moreover, the hydroxyl group enables adhesion-promoting interactions with mineral substrates.

U.S. Pat. No. 5,587,502 discloses hydroxycarbamoylsilanes, but these are not very pure after their preparation and have limited storage stability.

### SUMMARY OF THE INVENTION

It is therefore an object of the present invention to provide a hydroxysilane for use as an adhesion promoter or crosslinker for adhesives or sealants or coatings, which has good storage stability and enables good adhesion properties.

It has been found that, surprisingly, this object is achieved by a hydroxysilane of the formula (I) as described in claim 1.

The hydroxysilane of the formula (I) is preparable in very high purity in a simple process and surprisingly has excellent storage stability, even though it has very reactive trimethoxysilane groups. It shows a good adhesion promoter or crosslinker effect for adhesives or sealants or coatings. For this purpose, it may be present as a constituent of an adhesion promoter composition for the pretreatment of substrates to which the adhesive or sealant or the coating is applied, or it may be present as a constituent of the adhesive or sealant or the coating itself, where it acts as an adhesion promoter and/or crosslinker. Further aspects of the invention are the subject of further independent claims. Particularly preferred embodiments of the invention are the subject of the dependent claims.

### WAYS OF EXECUTING THE INVENTION

The invention provides for the use of a hydroxysilane of the formula (I) as an adhesion promoter or crosslinker for adhesives or sealants or coatings

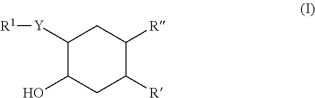

where

either R′ is a radical of the formula (II) and R″ is a hydrogen radical or R′ is a hydrogen radical and R″ is a radical of the formula (II);

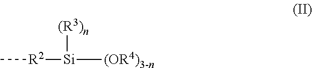

R¹ is an aliphatic or cycloaliphatic or arylaliphatic hydrocarbyl radical which has 1 to 18 carbon atoms and optionally has heteroatoms in the form of ether oxygen, ester oxygen, thioether sulfur or secondary or tertiary amine nitrogen, and which optionally has a silane group;

R² is a linear or branched alkylene or cycloalkylene radical having 1 to 20 carbon atoms, optionally having aromatic components, and optionally having one or more heteroatoms;

R³ is an alkyl radical having 1 to 8 carbon atoms;

R⁴ is an aliphatic or cycloaliphatic or arylaliphatic hydrocarbyl radical which has 1 to 12 carbon atoms and optionally has one or two ether oxygens;

Y is O or is S or NR⁰ where R⁰ is a hydrogen atom or is an alkyl radical which has a silane group and has 1 to 12 carbon atoms; and

n is 0 or 1 or 2.

In the present document, the term “alkoxysilane group” or “silane group” for short refers to a silyl group which is bonded to an organic radical and has one to three, especially two or three, hydrolyzable alkoxy radicals on the silicon atom. A “methoxysilane group” refers to a silane group having exclusively methoxy radicals as alkoxy radicals. An “ethoxysilane group” refers to a silane group having exclusively ethoxy radicals as alkoxy radicals.

The term “alkoxysilane” or “silane” for short refers to an organic compound having at least one silane group.

“Hydroxysilane”, “epoxysilane”, “isocyanatosilane”, “aminosilane” and “mercaptosilane” refer respectively to silanes having one or more hydroxyl, epoxy, isocyanato, amino and mercapto groups on the organic radical in addition to the silane group.

Substance names beginning with “poly”, such as polyol or polyisocyanate, refer to substances which, in a formal sense, contain two or more of the functional groups that occur in their name per molecule.

“Molecular weight” in the present document refers to the molar mass (in grams per mole) of a molecule. “Average molecular weight” is understood to mean the number average Mₙ of an oligomeric or polymeric mixture of molecules, which is typically determined by means of gel permeation chromatography (GPC) against polystyrene as standard.

“Storage-stable” or “storable” refers to a substance or composition when it can be stored at room temperature in a suitable container over a prolonged period, typically at least 3 months up to 6 months or more, without undergoing any change to a degree of relevance for its use in its application or use properties, especially in the viscosity and the crosslinking rate, as a result of the storage. A dotted line in the formulae in this document in each case represents the bond between a substituent and the corresponding remainder of the molecule. “Room temperature” refers to a temperature of 23° C.

The hydroxysilane of the formula (I) corresponds either to the formula (Ia) or to the formula (Ib).

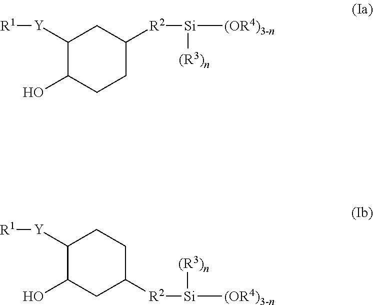

In the formulae (Ia) and (Ib), R¹, R², R³, R⁴, Y and n have the definitions already given above.

The formulae (Ia) and (Ib) include all the diastereomers possible for the particular structure.

Preferably, Y is O or is NR⁰. These hydroxysilanes are advantageous in terms of odor.

More preferably, Y is O and R¹ is an aliphatic or cycloaliphatic or arylaliphatic hydrocarbyl radical which has 1 to 12 and especially 1 to 8 carbon atoms and optionally has one or two ether oxygens.

More particularly, Y is O and R¹ is a methyl radical or is an ethyl radical.

In addition, more preferably, Y is NR⁰, R⁰ is a hydrogen atom and R¹ is an aliphatic or cycloaliphatic or arylaliphatic hydrocarbyl radical which has 1 to 12 and especially 1 to 8 carbon atoms and optionally has one or two ether oxygens or one or two secondary or tertiary amino groups.

More particularly, R¹ here is n-propyl, isopropyl, n-butyl, sec-butyl, tert-butyl, isopentyl, n-hexyl, n-octyl, 2-ethylhexyl, cyclohexyl, benzyl, phenylethyl, 2-methoxyethyl, 2-ethoxyethyl, 3-methoxypropyl, 3-ethoxypropyl, 3-(2-methoxyethoxy)propyl or N,N-dimethyl-3-aminopropyl.

In a further preferred embodiment of the invention, Y is S or NR⁰ and R¹ is an aliphatic hydrocarbyl radical which has 1 to 12 carbon atoms and has a silane group and optionally has a secondary amino group. These hydroxysilanes are particularly suitable as crosslinkers.

More particularly, R¹ here is 3-trimethoxysilylpropyl, 3-triethoxysilylpropyl, 3-trimethoxysilylpropylaminoethyl or 3-triethoxysilylpropylaminoethyl.

More particularly, R⁰ here is a hydrogen atom or is 3-trimethoxysilylpropyl or is 3-triethoxysilylpropyl.

Preferably, R² is an alkylene radical having 1 to 6 carbon atoms, especially a 1,2-ethylene radical.

Preferably, R³ is a methyl radical.

Preferably, R⁴ is a methyl radical or an ethyl radical. These hydroxysilanes are particularly reactive.

R⁴ is especially a methyl radical. These hydroxysilanes are particularly reactive with moisture.

R⁴ is also especially an ethyl radical. These hydroxysilanes do not eliminate any methanol as they are hydrolyzed, which is advantageous for toxicological reasons.

Preferably, n is 0 or 1, especially 0.

The preferred hydroxysilanes are obtainable particularly efficiently and preparable in particularly pure quality.

Preferably, the hydroxysilane of the formula (I) is prepared by reaction of at least one epoxysilane of the formula (II) with at least one alcohol or thiol or amine of the formula (III).

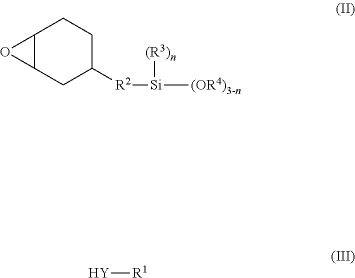

In the formulae (II) and (III), R¹, R², R³, R⁴, Y and n have the definitions already given above.

An alcohol or thiol or amine of the formula (III) may be added on here at the carbon either in the 2 or 3 position to the carbon atom to which the substituent containing silane groups is bonded, giving rise either to a hydroxysilane of the formula (Ia) or a hydroxysilane of the formula (Ib). This reaction typically affords mixtures of the two hydroxysilanes of the formula (Ia) and (Ib).

The reaction product from this reaction is particularly suitable for the described use as adhesion promoter or crosslinker.

The reaction is preferably conducted at temperatures in the range from 50 to 140° C., especially 70 to 120° C.

If an alcohol of the formula (III) is used, it is preferably chosen such that the R¹ radical is the same as the R⁴ radical of the epoxysilane of the formula (II). The alcohol of the formula (III) is preferably used in a stoichiometric or superstoichiometric ratio in relation to the epoxysilane of the formula (II). More particularly, an alcohol/epoxysilane ratio in the range from 1.0 to 6.0, preferably 2.0 to 5.0, is employed.

If an amine of the formula (III) is used, it is preferably used in a stoichiometric or superstoichiometric ratio in relation to the epoxysilane of the formula (II).

More particularly, an amine/epoxysilane ratio in the range from 1.0 to 2.0, preferably 1.0 to 1.5, is employed.

If a thiol of the formula (III) is used, it is preferably used in a substoichiometric or stoichiometric ratio in relation to the epoxysilane of the formula (II). More particularly, a thiol/epoxysilane ratio in the range from 0.5 to 1.0, preferably 0.8 to 1.0, is employed. Excess thiol can lead to odor or toxicological problems.

It is possible to use a catalyst in the reaction, especially an imidazole, a hydroxyalkylamine, an alcohol, a phenol, a Brønsted acid such as, more particularly, acetic acid or methanesulfonic acid, a Lewis acid such as, more particularly, aluminum(III) acetylacetonate, aluminum(III) isopropoxide, aluminum(III) ethoxide, lanthanum(III) triflate, zinc dichloride or zinc bis(ethylhexanoate), or a metal salt such as, more particularly, sodium dodecylsulfate or lithium perchlorate.

Preferably, after the reaction, any volatile compounds present, especially excess alcohol and/or excess amine, are removed from the reaction product, especially by distillation.

If an alcohol of the formula (III) in which the R¹ radical differs from the R⁴ radical of the silane group is used, it is possible for transesterification reactions on the silane group to occur during the preparation, forming hydroxysilanes with alkoxysilane groups derived from the alcohol of the formula (III) used. The reaction product obtained from the preferred execution of the reaction typically contains at least 80% by weight, especially at least 85% by weight, of hydroxysilanes of the formula (I). The high purity is surprising, given that hydroxysilanes according to the prior art typically have contents of impurities of 20% by weight or more.

The epoxysilane of the formula (II) used is preferably a β-(3,4-epoxycyclohexyl)ethyltrialkoxysilane. Particularly suitable examples are β-(3,4-epoxycyclohexyl)ethyltrimethoxysilane, commercially available, for example, as Silquest® A-186 (from Momentive Performance Materials), or β-(3,4-epoxycyclohexyl)ethyltriethoxysilane, commercially available, for example, as CoatOSil® 1770 (from Momentive Performance Materials).

Suitable alcohols of the formula (III) are aliphatic or cycloaliphatic or arylaliphatic alcohols, especially methanol, ethanol, 1-propanol, isopropanol, 1-butanol, 2-butanol, isobutanol, 1-pentanol (amyl alcohol), isopentanol (isoamyl alcohol), 2-methyl-1-butanol, 2-pentanol, 3-pentanol, 1-hexanol, 2-methyl-1-pentanol, 4-methyl-2-pentanol, 2-ethyl-1-butanol, 1-heptanol, 1-octanol, 2-ethyl-1-hexanol, 1-nonanol, 1-decanol, 1-undecanol, 1-dodecanol, 1-methoxy-2-propanol, 2-methoxyethanol (methylglycol), 2-(2-methoxyethoxy)ethanol (methyldiglycol), cyclohexanol, 2-methylcyclohexanol, 4-methylcyclohexanol, benzyl alcohol, 2-methylbenzyl alcohol, 4-methylbenzyl alcohol, 4-ethylbenzyl alcohol, 4-isopropylbenzyl alcohol, 4-tert-butylbenzyl alcohol, 4-methoxybenzyl alcohol, N,N-dimethylethanolamine, N,N-diethylethanolamine, N,N-dibutylethanolamine or N-(2-hydroxyethyl)morpholine.

Among these, preference is given to methanol, ethanol, isopropanol, 1-butanol, isobutanol, 1-pentanol, 1-hexanol, 2-methoxyethanol, 2-(2-methoxyethoxy)ethanol, cyclohexanol or benzyl alcohol.

Particular preference is given to methanol or ethanol.

Particularly advantageously, the alcohol of the formula (III) employed is methanol in the case of use of an epoxysilane having methoxysilane groups, and is ethanol in the case of use of an epoxysilane having ethoxysilane groups.

Suitable thiols of the formula (III) are aliphatic or cycloaliphatic or arylaliphatic thiols, especially 2-(2-methoxyethoxy)ethanethiol, methyl thioglycolate, ethyl thioglycolate, 2-ethylhexyl thioglycolate, methyl 3-mercaptopropionate, ethyl 3-mercaptopropionate or 2-ethylhexyl 3-mercaptopropionate, or mercaptosilanes such as, more particularly, 3-mercaptopropyltrimethoxysilane or 3-mercaptopropyltriethoxysilane. Among these, preference is given to 2-(2-methoxyethoxy)ethanethiol, 2-ethylhexyl thioglycolate, 3-mercaptopropyltrimethoxysilane or 3-mercaptopropyltriethoxysilane, especially 3-mercaptopropyltrimethoxysilane or 3-mercaptopropyltriethoxysilane.

Suitable amines of the formula (III) are aliphatic, cycloaliphatic and arylaliphatic primary amines and amino silanes, especially ethylamine, the isomeric propylamines, butylamines, pentylamines, hexylamines, octylamines or decylamines, and also cyclohexylamine, benzylamine, phenylethylamine, 2- or 4-methoxyphenylethylamine, homoveratrylamine, and also fatty amines such as, more particularly, cocoalkylamine, N-cocoalkyl-1,3-propanediamine, oleylamine, and also ether amines such as, more particularly, 2-methoxyethylamine, 2-ethoxyethylamine, 3-methoxypropylamine, 3-ethoxypropylamine, 3-(2-ethylhexoxy)propylamin or 3-(2-methoxyethoxy)propylamine, and also amines having two or more amino groups, such as, more particularly, N,N-dimethyl-1,3-diaminopropane, N-methyl-1,2-ethanediamine, N-methyl-1,3-propanediamine, N-(2-aminopropyl)piperazine, N-(2-aminoethyl)piperazine, N¹-(3-dimethylamino)propyl-1,3-diaminopropane, and also aminosilanes such as, more particularly, 3-aminopropyltrimethoxysilane, 3-aminopropyltriethoxysilane, 3-aminopropyldimethoxymethylsilane, N-(2-aminoethyl)aminopropyltrimethoxysilane, N-(2-aminoethyl)aminopropyltriethoxysilane, bis(3-trimethoxysilyl)propyl)amine or bis(3-triethoxysilyl)propyl)amine.

Among these, preference is given to propylamine, isopropylamine, butylamine, sec-butylamine, tert-butylamine, hexylamine, octylamine, 2-ethylhexylamine, cyclohexylamine, benzylamine, phenylethylamine, 2-methoxyethylamine, 2-ethoxyethylamine, 3-methoxypropylamine, 3-ethoxypropylamine, 3-(2-methoxyethoxy)propylamine, N,N-dimethyl-1,3-diaminopropane, 3-aminopropyltrimethoxysilane, 3-aminopropyltriethoxysilane, 3-aminopropyldimethoxymethylsilane, N-(2-aminoethyl)aminopropyltrimethoxysilane or N-(2-aminoethyl)aminopropyltriethoxysilane.

Preferred alcohols or thiols or amines of the formula (III) are alcohols or amines.

Preferred alcohols or thiols or amines of the formula (III) are additionally aminosilanes or mercaptosilanes.

The hydroxysilane of the formula (I) is preferably selected from the group consisting of 2-methoxy-4-(2-trimethoxysilylethyl)cyclohexan-1-ol, 2-ethoxy-4-(2-trimethoxysilylethyl)cyclohexan-1-ol, 2-isopropoxy-4-(2-trimethoxysilylethyl)cyclohexan-1-ol, 2-butoxy-4-(2-trimethoxysilylethyl)cyclohexan-1-ol, 2-isobutoxy-4-(2-trimethoxysilylethyl)cyclohexan-1-ol, 2-pentoxy-4-(2-trimethoxysilylethyl)cyclohexan-1-ol, 2-hexoxy-4-(2-trimethoxysilylethyl)cyclohexan-1-ol, 2-(2-methoxyethoxy)-4-(2-trimethoxysilylethyl)cyclohexan-1-ol, 2-(2-methoxyethoxy)ethoxy-4-(2-trimethoxysilylethyl)cyclohexan-1-ol, 2-cyclohexoxy-4-(2-trimethoxysilylethyl)cyclohexan-1-ol, 2-benzoxy-4-(2-trimethoxysilylethyl)cyclohexan-1-ol, and the corresponding compounds which are obtained by partial or full transesterification of the trimethoxysilane groups with the alcohol of the abovementioned hydroxysilanes used for the preparation, and 2-propylamino-4-(2-trimethoxysilylethyl)cyclohexan-1-ol, 2-isopropylamino-4-(2-trimethoxysilylethyl)cyclohexan-1-ol, 2-butylamino-4-(2-trimethoxysilylethyl)cyclohexan-1-ol, 2-sec-butylamino-4-(2-trimethoxysilylethyl)cyclohexan-1-ol, 2-tert-butylamino-4-(2-trimethoxysilylethyl)cyclohexan-1-ol, 2-hexylamino-4-(2-trimethoxysilylethyl)cyclohexan-1-ol, 2-octylamino-4-(2-trimethoxysilylethyl)cyclohexan-1-ol, 2-(2-ethylhexyl)amino-4-(2-trimethoxysilylethyl)cyclohexan-1-ol, 2-cyclohexylamino-4-(2-trimethoxysilylethyl)cyclohexan-1-ol, 2-benzylamino-4-(2-trimethoxysilylethyl)cyclohexan-1-ol, 2-phenylethylamino-4-(2-trimethoxysilylethyl)cyclohexan-1-ol, 2-methoxyethylamino-4-(2-trimethoxysilylethyl)cyclohexan-1-ol, 2-(2-ethoxyethyl)amino-4-(2-trimethoxysilylethyl)cyclohexan-1-ol, 2-(3-methoxypropyl)amino-4-(2-trimethoxysilylethyl)cyclohexan-1-ol, 2-(3-ethoxypropyl)amino-4-(2-trimethoxysilylethyl)cyclohexan-1-ol, 2-(3-(2-methoxyethoxy)propyl)amino-4-(2-trimethoxysilylethyl)cyclohexan-1-ol, 2-(N,N-dimethyl-3-aminopropyl)amino-4-(2-trimethoxysilylethyl)cyclohexan-1-ol, 2-(3-trimethoxysilylpropyl)amino-4-(2-trimethoxysilylethyl)cyclohexan-1-ol, 2-(3-trimethoxysilylpropylaminoethyl)amino-4-(2-trimethoxysilylethyl)cyclohexan-1-ol, 2-(3-trimethoxysilylpropyl)mercapto-4-(2-trimethoxysilylethyl)cyclohexan-1-ol, and the corresponding compounds having triethoxysilane groups rather than trimethoxysilane groups, and also the corresponding compounds in which the silane group-containing substituent is in the 5 position rather than in the 4 position.

Among these, preference is given to 2-methoxy-4-(2-trimethoxysilylethyl)cyclohexan-1-ol, 2-ethoxy-4-(2-triethoxysilylethyl)cyclohexan-1-ol, 2-(2-methoxyethoxy)ethoxy-4-(2-tris(2-(2-methoxyethoxy)ethoxy)silylethyl)cyclohexan-1-ol, 2-hexylamino-4-(2-trimethoxysilylethyl)cyclohexan-1-ol, 2-hexylamino-4-(2-triethoxysilylethyl)cyclohexan-1-ol, 2-(3-trimethoxysilylpropyl)amino-4-(2-trimethoxysilylethyl)cyclohexan-1-ol, 2-(3-triethoxysilylpropyl)amino-4-(2-triethoxysilylethyl)cyclohexan-1-ol, 2-(3-trimethoxysilylpropylaminoethyl)amino-4-(2-trimethoxysilylethyl)cyclohexan-1-ol, 2-(3-triethoxysilylpropylaminoethyl)amino-4-(2-triethoxysilylethyl)cyclohexan-1-ol, 2-(3-trimethoxysilylpropyl)mercapto-4-(2-trimethoxysilylethyl)cyclohexan-1-ol, 2-(3-triethoxysilylpropyl)mercapto-4-(2-triethoxysilylethyl)cyclohexan-1-ol, or the corresponding compounds in which the silane group-containing substituent is in the 5 position rather than in the 4 position.

Most preferred is 2-ethoxy-4(5)-(2-triethoxysilylethyl)cyclohexan-1-ol or 2-methoxy-4(5)-(2-trimethoxysilylethyl)cyclohexan-1-ol.

Mixtures of two compounds wherein the substituent containing silane groups is in the 4 or in the 5 position are represented by the notation “4(5)”.

The hydroxysilane of the formula (I) is very storage-stable with exclusion of moisture. At room temperature, barely any decrease in the purity is detected over a period of several months, not just for those having ethoxy groups, but also, surprisingly, for hydroxysilanes of the formula (I) that contain methoxy groups, which are much more reactive.

The silane groups of the hydroxysilane of the formula (I) have the property of being hydrolyzed on contact with moisture. This forms organosilanols (organosilicon compounds containing one or more silanol groups, Si—OH groups) and, through subsequent condensation reactions, organosiloxanes (organosilicon compounds containing one or more siloxane groups, Si—O—Si groups), releasing the corresponding alcohol, for example ethanol in the case of ethoxysilane groups.

The—at least partial—hydrolysis of at least one hydroxysilane of the formula (I) affords compounds having at least one silanol group of the formula (IV).

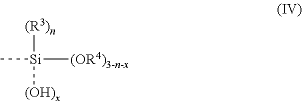

In the formula (IV), x is 1 or 2 or 3, with the proviso that x has not more than the value of (3-n). R³, R⁴ and n have the definitions already given. Such hydrolyzed or partially hydrolyzed compounds having silanol groups of the formula (IV) are very reactive and can very quickly react further, either through condensation with further silanol groups to form siloxane groups (Si—O—Si groups) or, for example, through condensation with hydroxyl groups of a substrate.

The hydroxysilane of the formula (I) has the ability to build up strong adhesion with various substrates, or to improve the adhesion of compositions comprising this silane to a substrate, or to improve the adhesion of curable compositions that are applied to a layer containing the hydroxysilane on said layer. A hydroxysilane of the formula (I) having two or three silane groups additionally has the ability to act as a particularly good crosslinker with itself or with other compositions containing silane groups.

The hydroxysilane of the formula (I) is used as an adhesion promoter or crosslinker for adhesives or sealants or coatings.

Suitable adhesives or sealants or coatings are especially compositions comprising at least one curable binder and optionally further constituents such as, more particularly, fillers, crosslinkers, plasticizers, solvents, catalysts, adhesion promoters, drying agents, stabilizers, pigments and/or rheology aids.

A suitable curable binder preferably contains reactive groups selected from acrylate groups, methacrylate groups, epoxy groups, isocyanate groups and silane groups.

The curable binder is preferably selected from poly(meth)acrylates, polyisocyanates, polyurethane polymers containing isocyanate groups, polymers containing silane groups, polyurethane polymers containing isocyanate and silane groups, and combinations thereof.

Suitable poly(meth)acrylates are especially methyl (meth)acrylate, ethyl (meth)acrylate, n-butyl (meth)acrylate, n-hexyl (meth)acrylate, 2-ethylhexyl methacrylate, lauryl (meth)acrylate, stearyl (meth)acrylate, cyclohexyl (meth)acrylate, tetrahydrofuryl (meth)acrylate, isobornyl (meth)acrylate, 2-hydroxyethyl (meth)acrylate, tris(2-hydroxyethyl) isocyanurate tri(meth)acrylate, tris(2-hydroxyethyl) cyanurate tri(meth)acrylate, N,N′,N″-tris(meth)acryloylperhydrotriazine; di- or polyfunctional acrylates or methacrylates of aliphatic polyethers, polyesters, novolaks, phenols, aliphatic or cycloaliphatic alcohols, glycols or polyester glycols, or of mono- or polyalkoxylated derivatives of the aforementioned compounds, for example ethylene glycol di(meth)acrylate, tetraethylene glycol di(meth)acrylate, tripropylene glycol di(meth)acrylate, polyethylene glycol di(meth)acrylate, polypropylene glycol di(meth)acrylate, butane-1,4-diol di(meth)acrylate, hexane-1,6-diol di(meth)acrylate, neopentyl glycol di(meth)acrylate, trimethylolpropane tri(meth)acrylate, pentaerythritol tetra(meth)acrylate, dipentaerythritol tetra(meth)acrylate, dipentaerythritol penta(meth)acrylate, dipentaerythritol hexa(meth)acrylate; di- or poly-acryloyl- or -methacryloyl-functional polybutadienes, polyisoprenes or block copolymers thereof; adducts of di- or polyfunctional epoxides with acrylic or methacrylic acid; or polyurethane (meth)acrylates.

Suitable polyisocyanates are especially aliphatic, arylaliphatic, cycloaliphatic or aromatic monomeric diisocyanates, especially hexamethylene 1,6-diisocyanate (HDI), 2,2,4- and 2,4,4-trimethylhexamethylene 1,6-diisocyanate (TMDI), 1-methyl-2,4- and/or -2,6-diisocyanatocyclohexane or any desired mixtures of these isomers (HTDI or H₆TDI), 1-isocyanato-3,3,5-trimethyl-5-isocyanatomethylcyclohexane (isophorone diisocyanate or IPDI) or perhydrodiphenylmethane 2,4′- and/or 4,4′-diisocyanate (HMDI or H₁₂MDI), tolylene 2,4- and/or 2,6-diisocyanate or any desired mixtures of these isomers (TDI), diphenylmethane 4,4′-, 2,4′- and/or 2,2′-diisocyanate or any desired mixtures of these isomers (MDI), phenylene 1,3- or 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI) or dianisidine diisocyanate (DADI). Among these, preference is given to HDI, IPDI, MDI or TDI. Suitable polyisocyanates are additionally especially oligomers or derivatives of the diisocyanates mentioned, especially those derived from HDI, IPDI, MDI or TDI, especially commercially available products, especially HDI biurets, HDI isocyanurates, HDI uretdiones, HDI iminooxadiazinediones, HDI allophanates, IPDI isocyanurates, TDI oligomers, mixed isocyanurates based on TDI/HDI, room temperature liquid forms of MDI (called “modified MDI”), which are mixtures of MDI with MDI derivatives such as, more particularly, MDI carbodiimides or MDI uretonimines or MDI urethanes, or mixtures of MDI and MDI homologs (polymeric MDI or PMDI). The oligomeric polyisocyanates mentioned are in practice typically mixtures of substances having different oligomerization levels and/or chemical structures and preferably have a mean NCO functionality in the range from 2.1 to 4.0.

Suitable polyurethane polymers containing isocyanate groups are especially reaction products of at least one polyol with a superstoichiometric amount of at least one polyisocyanate, polyols used with preference being polyether polyols, polyester polyols, polycarbonate polyols or polyacrylate polyols, more preferably polyether polyols, especially polyoxypropylene polyols and/or polyoxyethylene-polyoxypropylene copolyols, preferably having an average molecular weight in the range from 500 to 30′000 g/mol, preferably 1000 to 20′000 g/mol, especially 1000 to 15′000 g/mol, and where the polyisocyanates used are preferably the monomeric diisocyanates mentioned, preferably MDI, TDI, HDI or IPDI. They can be prepared with additional use of small polyfunctional alcohols such as, more particularly, butane-1,4-diol.

Suitable polymers containing silane groups are especially commercial types such as, more particularly, products known by the trade names MS Polymer™ (from Kaneka Corp.; especially the products 5203H, 5303H, S227, S810, MA903 or S943); MS Polymer™ or Silyl™ (from Kaneka Corp.; especially the products SAT010, SAT030, SAT200, SAX350, SAX400, SAX725, MAX450, MAX602 or MAX951); Excestar® (from Asahi Glass Co. Ltd.; especially the products S2410, S2420, S3430 or S3630); SPUR+* (from Momentive Performance Materials; especially the products 1010LM, 1015LM or 1050MM); Vorasil™ (from Dow Chemical Co.; especially the products 602 or 604); Desmoseal® (from Bayer MaterialScience AG; especially the products S XP 2636, S XP 2749, S XP 2774 or S XP 2821); TEGOPAC® (from Evonik Industries AG; especially the products Seal 100, Bond 150 or Bond 250); or Geniosil® STP (from Wacker Chemie AG; especially the products E15 or E35).

Suitable polymers containing silane groups and/or suitable polyurethane polymers containing isocyanate and silane groups are additionally especially reaction products of polyurethane polymers containing isocyanate groups, as described previously, with aminosilanes or mercaptosilanes or hydroxysilanes, with conservation of isocyanate groups in the substoichiometric reaction.

The adhesive or sealant or the coating may take the form of a one-component composition or of a multicomponent composition, especially of a two-component composition. It can cure with moisture or as a result of contact with a hardener, optionally with the aid of heat.

A “one-component” composition in the present document refers to a composition in which all the constituents of the composition are stored in a mixture in the same container and which is especially curable with moisture. A “two-component” composition in the present document refers to a composition in which the constituents of the composition are present in two different components which are stored in separate containers. Only shortly before or during the application of the composition are the two components mixed with one another, and the mixed composition then cures.

The adhesive or sealant may have a pasty consistency at room temperature and be applied to a substrate in the form of beads, or it may have a liquid consistency at room temperature and be applied to the full area of a substrate, or it may be solid at room temperature and be applied in the heated, molten state.

The coating may have a liquid or slightly pasty consistency at room temperature and be applied over the full area of a substrate, or it may be solid at room temperature and be applied in the heated, molten state. Typically, it has a liquid or slightly pasty consistency at room temperature and can be applied, for example, by means of a brush, roll, spatula or trowel or—on flat surfaces—even in a self-leveling manner.

The adhesive or sealant or the coating is suitable for a multitude of uses, especially as a joint sealant, weld or flange seam sealant, parquet adhesive, assembly adhesive, bodywork adhesive, glazing adhesive, sandwich element adhesive, floor covering, floor coating, balcony coating, roof coating, concrete protection coating, parking garage coating, and also as anticorrosion paint or as a seal or paint.

The adhesive is additionally suitable as a hotmelt adhesive, especially as a laminating adhesive, laminate adhesive, packaging adhesive, textile adhesive or wood adhesive.

Preference is given to elastic adhesives and/or sealants for joint sealing or for elastic adhesive bonds in construction or industrial applications.

Preference is further given to elastic coatings, and to varnishes or seals.

Suitable substrates to which the adhesive or sealant or the coating can be applied are especially
glass, glass ceramic, screen-printed ceramic, concrete, mortar, brick, tile, gypsum or natural stone such as granite or marble;
metals or alloys such as aluminum, iron, steel and nonferrous metals, or surface-finished metals and alloys such as galvanized or chromed metals;
leather, textiles, paper, wood, wood-based materials bonded with resins, for example phenolic, melamine or epoxy resins, resin-textile composites or further polymer composites;
plastics, especially rigid or flexible PVC, ABS, polycarbonate (PC), polyamide (PA), polyester, PMMA, epoxy resins, PUR, POM, PO, PE, PP, EPM or EPDM, optionally with surface treatment of the plastics by means of plasma, corona or flames;
fiber-reinforced plastics, such as carbon fiber-reinforced plastics (CFP), glass fiber-reinforced plastics (GFP) or sheet molding compounds (SMC);
coated substrates, such as powder-coated metals or alloys;
paints or lacquers, especially automotive topcoats.

It is possible for two identical or two different substrates to be bonded and/or sealed.

The substrates can be pretreated if required prior to the application of the adhesive or sealant or the coating, especially by physical and/or chemical cleaning methods or the application of an adhesion promoter solution or a primer.

The hydroxysilane of the formula (I) can be used as an adhesion promoter for adhesives or sealants or coatings in that the hydroxysilane is applied to a substrate as a constituent of an adhesion promoter composition, and then, especially after a suitable flash-off time, the adhesive or sealant or the coating is applied to the pretreated substrate.

The hydroxysilane of the formula (I) can additionally be used as an adhesion promoter or crosslinker for adhesives or sealants or coatings in that the hydroxysilane is a constituent of the adhesive or sealant or the coating.

In one embodiment of the use, the hydroxysilane is a constituent of an adhesion promoter composition.

The invention accordingly further provides an adhesion promoter composition comprising at least one hydroxysilane of the formula (I) as previously described and at least one solvent.

Suitable solvents are especially methanol, ethanol, isopropanol, acetone, methyl ethyl ketone, methyl n-propyl ketone, diisobutyl ketone, methyl isobutyl ketone, methyl n-amyl ketone, methyl isoamyl ketone, acetylacetone, mesityl oxide, cyclohexanone, methylcyclohexanone, ethyl acetate, propyl acetate, butyl acetate, n-butyl propionate, diethyl malonate, 1-methoxy-2-propyl acetate, ethyl 3-ethoxypropionate, diisopropyl ether, diethyl ether, dibutyl ether, diethylene glycol diethyl ether, ethylene glycol diethyl ether, ethylene glycol monopropyl ether, ethylene glycol mono-2-ethylhexyl ether, toluene, xylene, heptane, octane, naphtha, white spirit, petroleum ether or benzine, especially Solvesso™ products (from Exxon), and also methylene chloride, propylene carbonate, butyrolactone, N-methylpyrrolidone, N-ethylpyrrolidone or water.

Optionally, the adhesion promoter composition comprises further constituents such as, more particularly, catalysts, further silanes, titanates or zirconates, or optionally pigments, fillers, wetting agents, polyisocyanates, polyurethane polymers having isocyanate and/or silane groups, or epoxy resins.

An adhesion promoter composition consisting mainly of solvents and comprising especially silanes and/or catalysts and/or titanates and/or zirconates as additional constituents is also referred to as an activator or as an adhesion promoter solution. Such an adhesion promoter solution is typically used to clean substrate surfaces and simultaneously prepare them for the subsequent application of an adhesive or sealant or a coating, so as to give rise to improved adhesion between the substrate and the adhesive or sealant or the coating. The dosages of the ingredients in an adhesion promoter composition are typically such that there is no continuous film remaining on the substrate surface after the solvents have evaporated.

The adhesion promoter solution is typically applied to a substrate surface in a thin layer by means of a cloth, a felt or a similar arrangement and optionally subsequently wiped off gently with a clean cloth. After a suitable delay time, the adhesive or sealant or the coating is applied to the surface thus pretreated and typically has improved adhesion.

An adhesion promoter composition which, as well as solvents and optionally silanes, catalysts, titanates or zirconates, additionally comprises a film-forming component and optionally pigments, fillers, wetting agents or further additives is also referred to as a primer. Suitable film-forming components are especially mono- and/or oligomeric aliphatic, cycloaliphatic, arylaliphatic or aromatic polyisocyanates, polymers having isocyanate and/or silane groups, oligomeric silane formulations, or epoxy resins. The primer is typically applied in such a way that, after the evaporation of the solvents, a continuous film remains on the substrate in a layer thickness within the range from a few micrometers up to a few hundred micrometers. A primer is typically used to improve the adhesion between a substrate and an adhesive and/or sealant or a coating in that the primer film can build up adhesion both to the substrate and to the curable composition applied to the primer film.

The primer is typically applied to a substrate surface in a thin layer with a brush or a roll. After a suitable delay time, during which the solvent evaporates partly or fully, the adhesive or sealant or the coating is applied to the surface thus pretreated and typically has improved adhesion.

In a further embodiment of the use, the hydroxysilane is a constituent of an adhesive or sealant or of a coating.

The invention accordingly further provides a composition usable as an adhesive or sealant or as a coating, comprising at least one hydroxysilane of the formula (I) as previously described.

Optionally, the composition comprises further constituents selected from curable binders, fillers, crosslinkers, plasticizers, solvents, catalysts, further adhesion promoters, drying agents, stabilizers, pigments and rheology aids.

In one embodiment of the invention, the composition, after curing, has an elongation at break of at least 10%, preferably at least 30%, especially at least 50%. Elongation at break is determined here on dumbbells having a thickness of 2 mm and a length of 75 mm with a bar length of 30 mm and a bar width of 4 mm according to DIN EN 53504 at a pulling speed of 200 mm/min.

Such a composition preferably comprises at least one curable binder selected from polyisocyanates, polyurethane polymers containing isocyanate groups, polymers containing silane groups, polyurethane polymers containing isocyanate and silane groups, and combinations thereof as previously described.

Such a composition preferably has a curable binder content in the range from 5% to 90% by weight, especially 10% to 60% by weight.

In a further embodiment of the invention, the composition is a coating in the form of a varnish or of a seal. Such a coating is typically applied in a layer thickness in the range from 30 to 800 μm of dry film, and it typically contains at least one solvent such as those previously mentioned. It is either substantially rigid or only slightly elastic and can protect a surface from mechanical or weather-related effects or from the attack of chemicals or solvents. The hydroxysilane of the formula (I) may be present here as adhesion promoter preferably in an amount in the range from 0.1% to 10% by weight, based on the dry film. Especially if the hydroxysilane of the formula (I) has two or three silane groups, it may also be present in a higher amount as crosslinker, especially in an amount in the range from 10% to 80% by weight, based on the dry film.

If the adhesion promoter composition or the composition usable as adhesive, sealant or coating includes constituents containing isocyanate groups, the hydroxysilane of the formula (I) can react therewith. This gives rise to an adduct containing silane groups that likewise acts as an adhesion promoter or crosslinker.

Suitable further constituents of an adhesion promoter composition or of a composition usable as adhesive, sealant or coating are especially the following:
catalysts, especially compounds of tin, iron, bismuth, zinc, manganese, chromium, cobalt, copper, nickel, molybdenum, lead, cadmium, mercury, antimony, vanadium, titanium, zirconium or potassium, especially organotin(IV) compounds such as dibutyltin diacetate, dibutyltin dilaurate, dimethyltin dilaurate, dibutyltin dichlorid, dibutyltin diacetylacetonate or dioctyltin dilaurate, bismuth(III) complexes, zinc(II) acetate, zinc(II) 2-ethylhexanoate, zinc(II) laurate, zinc(II) acetylacetonate, cobalt(II) 2-ethylhexanoate, copper(II) 2-ethylhexanoate, nickel(II) naphthenate, aluminum lactate, aluminum oleate, titanium(IV) complexes such as, more particularly, diisopropoxytitanium bis(ethylacetoacetate), zirconium(IV) complexes or potassium acetate; nitrogen-containing compounds such as, more particularly, 2,2′-dimorpholinodiethyl ether, N-ethyldiisopropylamine, N,N,N′,N′-tetramethylalkylenediamines, pentamethylalkylenetriamines or higher homologs thereof, bis(N,N-diethylaminoethyl) adipate, tris(3-dimethylaminopropyl)amine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-alkylmorpholines, N,N′-dimethylpiperazine, guanidines, 4-dimethylaminopyridine, N-methylimidazole, N-vinylimidazole or 1,2-dimethylimidazole, or organic ammonium compounds such as benzyltrimethylammonium hydroxide or alkoxylated tertiary amines; or combinations of the compounds mentioned, especially of metal compounds and nitrogen-containing compounds.
further silanes which can likewise act as adhesion promoters or crosslinkers, such as, more particularly, aminosilanes, mercaptosilanes, epoxysilanes, (meth)acryloylsilanes, isocyanatosilanes, carbamatosilanes, alkylsilanes, S-(alkylcarbonyl)mercaptosilanes or iminosilanes or oligomeric forms of these silanes.
hardeners or crosslinkers for the binders mentioned, especially polyols, polyamines, amino alcohols, aldimines, oxazolidines or aminosilanes.
inorganic and organic fillers, especially natural, ground or precipitated calcium carbonates optionally coated with fatty acids, especially stearic acid, baryte (heavy spar), talcs, quartz flours, quartz sand, dolomites, wollastonites, kaolins, calcined kaolins, mica, molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow beads.
fibers, especially glass fibers, carbon fibers, metal fibers, ceramic fibers, polymer fibers such as polyamide fibers or polyethylene fibers, or natural fibers.
dyes.
pigments, especially titanium dioxide or iron oxides.
plasticizers, especially carboxylic esters such as phthalates, especially dioctyl phthalate, diisononyl phthalate or diisodecyl phthalate, adipates, especially dioctyl adipate, azelates, sebacates, polyols, especially polyoxyalkylenepolyols or polyesterpolyols, glycol ethers, glycol esters, organic phosphoric or sulfonic esters, polybutenes, or fatty acid methyl or ethyl esters derived from natural fats or oils, also called “biodiesel”.
nonreactive polymers such as, more particularly, homo- or copolymers of unsaturated monomers, especially from the group comprising ethylene, propylene, butylene, isobutylene, isoprene, vinyl acetate and alkyl (meth)acrylates, especially polyethylenes (PE), polypropylenes (PP), polyisobutylenes, ethylene-vinyl acetate copolymers (EVA) or atactic poly-α-olefins (APAO).
solvents.
rheology modifiers, especially thickeners or thixotropic agents, for example sheet silicates such as bentonites, derivatives of castor oil, hydrogenated castor oil, polyamides, polyamide waxes, polyurethanes, urea compounds, fumed silicas, cellulose ethers and hydrophobically modified polyoxyethylenes.
drying agents, especially molecular sieves, calcium oxide, high-reactivity isocyanates such as p-tosyl isocyanate, monomeric diisocyanates, monooxazolidines such as Incozol® 2 (from Incorez), orthoformic esters, alkoxysilanes such as tetraethoxysilane or organoalkoxysilanes such as vinyltrimethoxysilane.
stabilizers against oxidation, heat, light and UV radiation.
flame-retardant substances.
surface-active substances, especially wetting agents, leveling agents, deaerators or defoamers.
biocides, for example algicides, fungicides or substances that inhibit fungal growth.

The use described results in an adhesive-bonded or sealed or coated article. This article may be a built structure or a component thereof, especially a built structure in construction or civil engineering, or it may be an industrial good or a consumer good, especially a window, a domestic appliance, or a means of transport such as, more particularly, an automobile, a bus, a truck, a rail vehicle, a ship, an aircraft or a helicopter, or an installable component thereof.

### EXAMPLES

Detailed hereinafter are working examples which are intended to illustrate the invention described in detail. Of course, the invention is not restricted to these described working examples.

“Standard climatic conditions” are understood to mean a temperature of 23±1° C. and a relative air humidity of 50±5%. “SCC” stands for “standard climatic conditions”.

¹H NMR spectra were measured in CDCl₃ on a Bruker Ascend 400 spectrometer at 400.14 MHz; the chemical shifts δ are reported in ppm relative to tetramethylsilane (TMS); the coupling constants J are reported in Hz.

Infrared spectra (FT-IR) were measured as undiluted films on a Nicolet iS5 FT-IR system, equipped with a horizontal ATR measurement unit with a diamond crystal, from Thermo Scientific; the absorption bands are reported in wavenumbers (cm⁻¹) (measurement window: 4000-650 cm⁻¹).

Gas chromatograms (GC) were measured in the temperature range from 60 to 320° C. with a heating rate of 15° C./min and a dwell time of 10 min at 320° C. The injector temperature was 250° C. A Zebron ZB-5 column was used (L=30 m, ID=0.25 mm, dj=0.5 μm) with a gas flow rate of 1.5 mL/min. Detection was effected by means of flame ionization (FID), with evaluation of the signals via the area percent method.

1. Hydroxysilanes:

### Hydroxysilane 1

### 2-Ethoxy-4(5)-(2-triethoxysilylethyl)cyclohexan-1-ol

In a round-bottom flask, 150.00 g of ethanol and 0.50 g of vinyltriethoxysilane were stirred under a nitrogen atmosphere at 50° C. for 15 min. Subsequently, 180.00 g (624 mmol) of β-(3,4-epoxycyclohexyl)ethyltriethoxysilane (CoatOSil® 1770, from Momentive) and 3.06 g of aluminum(III) isopropoxide were added, and the mixture was stirred at reflux at 100° C. under a nitrogen atmosphere for 16 h. Then the cloudy reaction mixture was cooled down to room temperature and filtered, and excess ethanol was evaporated on a rotary evaporator at 80° C. and 10 mbar. A colorless liquid product was obtained.

After the preparation, the product had a purity of 92% by weight (determined by means of gas chromatography). After storage with exclusion of moisture at room temperature for 3 months, the purity was unchanged.

FT-IR: 3444 (O—H), 2973, 2925, 2882, 2735, 1483, 1443, 1389, 1347, 1294, 1263, 1212, 1165, 1100, 1073, 1012, 953, 885, 860, 767, 710, 677.

¹H NMR: δ 3.81 (m, 6H, Si—O—CH₂—CH₃), 3.68 and 3.56 (2×m, 2×0.5 (OH)C^{cycl}H), 3.64 and 3.43 (2×m, 2×1H, C^{cycl}H—O—CH₂—CH₃), 3.27 and 3.13 (2×m, 2×0.5H, C^{cycl}H—O—CH₂—CH₃), 2.50 (m, 1H, C^{cycl}H), 1.80, 1.64 and 1.48 (3×m, 6H, C^{cycl}, H₂) 1.41 (m, 2H, C^{cycl}H—CH₂—CH₂—Si), 1.22 (m, 12H, Si—O—CH₂—CH₃), 0.61 (m, 2H, C^{cycl}H—CH₂—CH₂—Si).

GC: Four peaks at retention times from 12.57 min to 12.82 min with a total of 92 area % were detected, which were assigned to the diastereomers of 2-ethoxy-4-(2-triethoxysilylethyl)cyclohexan-1-ol and 2-ethoxy-5-(2-triethoxysilylethyl)cyclohexan-1-ol and were added up for the purity.

### Hydroxysilane 2

### 2-Methoxy-4(5)-(2-trimethoxysilylethyl)cyclohexan-1-ol

In a round-bottom flask, 104.35 g of methanol and 0.39 g of vinyltrimethoxysilane were stirred under a nitrogen atmosphere at 50° C. for 15 min. Then 153.74 g (624 mmol) of β-(3,4-epoxycyclohexyl)ethyltrimethoxysilane (Silquest® A-186, from Momentive) and 3.06 g of aluminum(III) isopropoxide were added and the cloudy mixture was reacted in 60 g portions in the microwave reactor, in each case at 140° C. and a pressure of about 12 bar for 30 min. Subsequently, the combined cloudy reaction mixtures were cooled down to room temperature and filtered, and excess methanol was evaporated on a rotary evaporator at 80° C. and 10 mbar. A colorless liquid product was obtained.

After the preparation, the product had a purity of 91% by weight (determined by means of gas chromatography). After storage with exclusion of moisture at room temperature for 3 months, the purity was unchanged.

FT-IR: 3456 (O—H), 2924, 2839, 1454, 1411, 1381, 1349, 1292, 1270, 1190, 1157, 1077, 997, 935, 908, 889, 874, 776, 710, 675.

¹H NMR: δ 3.73 and 3.61 (2×m, 2×0.5H, (OH)C^{cycl}H), 3.57 (d, 9H, Si—O—CH₃), 3.37 (d, 3H, C^{cycl}H—O—CH₃), 3.20 and 3.07 (2×m, 2×0.5H, C^{cycl}H—O—CH₃), 2.60 (m, 1H, C^{cycl}H), 1.82, 1.72, 1.63 and 1.46 (4×m, 6H, C^{cycl}H₂), 1.39 (q, 2H, C^{cycl}H—CH₂—CH₂—Si), 0.62 (m, 2H, C^{cycl}H—CH₂—CH₂—Si).

GC: Two peaks at retention times from 11.57 min to 11.68 min with a total of 91 area % were detected, which were assigned to the diastereomers of 2-methoxy-4-(2-trimethoxysilylethyl)cyclohexan-1-ol and 2-methoxy-5-(2-trimethoxysilylethyl)cyclohexan-1-ol and were added up for the purity.

### Hydroxysilane 3

Mixture comprising 2-(2-methoxyethoxy)ethoxy-4(5)-(2-tris(2-(2-methoxyethoxy)ethoxy)silylethyl)cyclohexan-1-ol, 2-(2-methoxyethoxy)ethoxy-4(5)-(2-ethoxybis(2-(2-methoxyethoxy)ethoxy)silylethyl)cyclohexan-1-ol and 2-(2-methoxyethoxy)ethoxy-4(5)-(2-diethoxy(2-(2-methoxyethoxy)ethoxy)silylethyl)cyclohexan-1-ol

In a round-bottom flask, 117.04 g of methyldiglycol (2-(2-methoxyethoxy)ethanol), 50.00 g (203 mmol) of β-(3,4-epoxycyclohexyl)ethyltrimethoxysilane (Silquest® A-186, from Momentive) and 0.50 g of aluminum(III) isopropoxide were stirred under a nitrogen atmosphere at 120° C. for 1 h. Subsequently, at constant temperature, a clear distillate was collected via an uncooled distillation attachment at 400 mbar over 2 h, at 300 mbar over a further 2 h and at 150 mbar over a further 3 h, which was identified as almost pure methanol with traces of methyldiglycol by FT-IR. The reaction mixture was stirred at 140° C. and 50 mbar for 24 hours, until it was no longer possible to collect any more distillate. Finally, the excess methyldiglycol was removed at 120° C. and 0.5 mbar. A colorless liquid product was obtained. FT-IR: 3473 (O—H), 2923, 2874, 2820, 1454, 1411, 1354, 1329, 1292, 1248, 1198, 1086, 1028, 958, 847, 770, 715, 681.

### Hydroxysilane 4

### 2-Hexylamino-4(5)-(2-triethoxysilylethyl)cyclohexan-1-ol

In a round-bottom flask, 17.37 g of hexylamine and 0.20 g of vinyltriethoxysilane were stirred under a nitrogen atmosphere at 50° C. for 15 min. Subsequently, 45.00 g (156 mmol) of β-(3,4-epoxycyclohexyl)ethyltriethoxysilane (CoatOSil® 1770, from Momentive) and 0.15 g of aluminum(III) acetylacetonate were added, and the mixture was stirred at reflux at 110° C. under a nitrogen atmosphere for 16 h. Then excess hexylamine was removed on a rotary evaporator at 80° C. and 10 mbar for 1 h. A colorless liquid product was obtained.

After the preparation, the product had a purity of 97.3% by weight (determined by means of gas chromatography). After storage with exclusion of moisture at room temperature for 3 months, the purity was unchanged.

FT-IR: 3297 (OH), 3152 (NH), 2971, 2924, 2882, 2857, 2735, 1613, 1454, 1410, 1389, 1365, 1294, 1166, 1101, 1075, 954, 906, 880, 767, 674.

¹H NMR: δ 3.81 (m, 6H, Si—O—CH₂—CH₃), 3.40 and 3.21 (2×m, 2×0.5H, (OH)C^{cycl}H), 2.73 (m, 1H, (C₆H₁₃—NH)C^{cycl}H), 2.46 and 2.38 and 2.24 (m, 2H, (C₅H₁₁—CH₂NH)C^{cycl}), 1.95 to 1.25 (m, 17H, 1×(R)₃C^{cycl}H, 3×(R)₂C^{cycl}H₂, CH₃—CH₂—CH₂—CH₂—CH₂—CH₂—NHR, 1×(R)₂HC^{cycl}—CH₂—CH₂—Si), 1.22 (m, 9H, Si—O—CH₂—CH₃), 0.89 (t, 3H, (CH₃—C₄H₈—NH)C^{cycl}), 0.61 (m, 2H, C^{cycl}H—CH₂—CH₂—Si). GC: Four peaks at retention times from 15.21 min to 15.73 min with a total of 97.3 area % were detected, which were assigned to the diastereomers of 2-hexylamino-4(5)-(2-triethoxysilylethyl)cyclohexan-1-ol and were added up for the purity. In addition, two peaks at retention times of 11.30 min and 11.34 min with a total of 2.7 area % were detected, which were assigned to the diastereomers of β-(3,4-epoxycyclohexy)ethyltriethoxysilane (reactant).

2. Adhesion Promoter Compositions

Adhesion Promoter Solution HL1 to HL4:

Four adhesion promoter solutions were prepared, by respectively dissolving 1.0% by weight of hydroxysilane 1 (=adhesion promoter HL1), 1.0% by weight of hydroxysilane 2 (=adhesion promoter HL2), 1.0% by weight of hydroxysilane 3 (=adhesion promoter HL3) and 1.0% by weight of hydroxysilane 4 (=adhesion promoter HL4) in solvent. Absolute ethanol was used for HL1 and HL4, absolute methanol for HL2, and ethyl acetate for HL3. The resultant adhesion promoter solutions HL1 to HL4 were each used as an activator on glass. For this purpose, spacer tape was stuck longitudinally onto the air side of glass plates (float glass; from Rocholl, Schönbrunn, Germany) with dimensions of 10×15 cm, so as to give three glass strips each of 2×13 cm in each case. Each strip was cleaned with acetone and then wiped either once with a hygiene tissue wetted with adhesion promoter solution or once with a hygiene tissue wetted with the respective solvent used (references). After a flash-off time of 2 h under standard climatic conditions, 7.8 g of an MDI polymer, the preparation of which is described below, per strip were applied in a layer thickness of about 3 mm. The glass plates were stored under standard climatic conditions.

After 4 days under standard climatic conditions, the MDI polymer had cured completely. On the strips that had been treated with the solvents only, the cured MDI polymer could be pulled away from the glass substrate with only little expenditure of force. It did not have good adhesion on the glass. On the strips treated with the adhesion promoter solutions HL1, HL2, HL3 and HL4, it was not possible to pull the cured MDI polymer off the glass substrate. Even after making several cuts transverse to the strip direction down to the glass substrate, with which the polymer was cut away from the glass, and pulling the polymer strip away in a perpendicularly upward direction, it was not possible to remove the MDI polymer from the glass substrate.

The MDI polymer used was prepared by reacting, with exclusion of moisture, 845 g of Acclaim® 4200 N polyol (polypropylene oxide diol, OH number 28.5 mg KOH/g, from Bayer) and 115 g of 4,4′-methylene diphenyl diisocyanate (MDI; Desmodur® 44 MC L, from Bayer) by known methods at 80° C. to give a polyurethane polymer having a content of free isocyanate groups, determined by titrimetry, of 1.96% by weight. The product was cooled to room temperature and stored with exclusion of moisture.

1. A method of using a hydroxysilane of the formula (I) 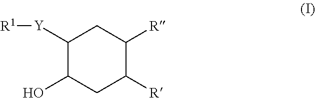
as adhesion promoter or crosslinker for adhesives or sealants or coatings, comprising:
applying the hydroxysilane to a substrate surface, and
subsequently or concurrently applying an adhesive, sealant, or coating to the substrate surface,
where
either R′ is a radical of the formula (II) and R″ is a hydrogen radical or R′ is a hydrogen radical and R″ is a radical of the formula (II); 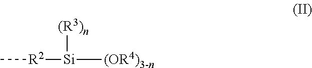
R¹ is an aliphatic or cycloaliphatic or arylaliphatic hydrocarbyl radical which has 1 to 18 carbon atoms and optionally has heteroatoms in the form of ether oxygen, ester oxygen, thioether sulfur or secondary or tertiary amine nitrogen, and which optionally has a silane group;
R² is a linear or branched alkylene or cycloalkylene radical having 1 to 20 carbon atoms, optionally having aromatic components, and optionally having one or more heteroatoms;
R³ is an alkyl radical having 1 to 8 carbon atoms;
R⁴ is an aliphatic or cycloaliphatic or arylaliphatic hydrocarbyl radical which has 1 to 12 carbon atoms and optionally has one or two ether oxygens;
Y is O or is S or NR⁰ where R⁰ is a hydrogen atom or is an alkyl radical which has a silane group and has 1 to 12 carbon atoms; and
n is 0 or 1 or 2.

2. The method as claimed in claim 1, wherein Y is O or is NR⁰.

3. The method as claimed in claim 2, wherein Y is O and R¹ is an aliphatic or cycloaliphatic or arylaliphatic hydrocarbyl radical which has 1 to 12 carbon atoms and optionally has one or two ether oxygens.

4. The method as claimed in claim 2, wherein Y is NR⁰, R⁰ is a hydrogen atom and R¹ is an aliphatic or cycloaliphatic or arylaliphatic hydrocarbyl radical which has 1 to 12 carbon atoms and optionally has one or two ether oxygens or one or two secondary or tertiary amino groups.

5. The method as claimed in claim 1, wherein Y is S or NR⁰ and R¹ is an aliphatic hydrocarbyl radical which has 1 to 12 carbon atoms and has a silane group and optionally has a secondary amino group.

6. The method as claimed in claim 1, wherein R² is a 1,2-ethylene radical.

7. The method as claimed in claim 1, wherein R⁴ is a methyl radical or is an ethyl radical.

8. The method as claimed in claim 1, wherein n is 0 or 1.

9. The method as claimed in claim 1, wherein the adhesive, sealant, or coating comprises at least one curable binder.

10. The method as claimed in claim 1, wherein the hydroxysilane is applied to the substrate surface as a constituent of an adhesion promoter composition to form a pretreated substrate, and then the adhesive, sealant, or coating is applied to the pretreated substrate.

11. The method as claimed in claim 1, wherein the hydroxysilane is a constituent of the adhesive, sealant, or coating.

12. An adhesion promoter composition comprising at least one hydroxysilane of the formula (I) and at least one solvent 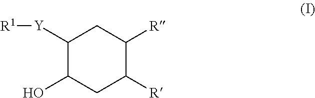
where
either R′ is a radical of the formula (II) and R″ is a hydrogen radical or R′ is a hydrogen radical and R″ is a radical of the formula (II); 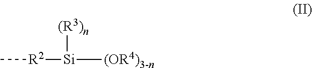
R¹ is an aliphatic or cycloaliphatic or arylaliphatic hydrocarbyl radical which has 1 to 18 carbon atoms and optionally has heteroatoms in the form of ether oxygen, ester oxygen, thioether sulfur or secondary or tertiary amine nitrogen, and which optionally has a silane group;
R² is a linear or branched alkylene or cycloalkylene radical having 1 to 20 carbon atoms, optionally having aromatic components, and optionally having one or more heteroatoms;
R³ is an alkyl radical having 1 to 8 carbon atoms;
R⁴ is an aliphatic or cycloaliphatic or arylaliphatic hydrocarbyl radical which has 1 to 12 carbon atoms and optionally has one or two ether oxygens;
Y is O or is S or NR⁰ where R⁰ is a hydrogen atom or is an alkyl radical which has a silane group and has 1 to 12 carbon atoms; and
n is 0 or 1 or 2.

13. A composition usable as an adhesive or sealant or coating, comprising at least one hydroxysilane of the formula (I) 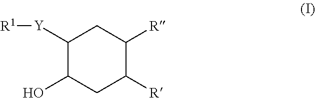
where
either R′ is a radical of the formula (II) and R″ is a hydrogen radical or R′ is a hydrogen radical and R″ is a radical of the formula (II); 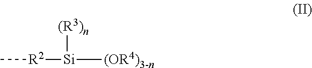
R¹ is an aliphatic or cycloaliphatic or arylaliphatic hydrocarbyl radical which has 1 to 18 carbon atoms and optionally has heteroatoms in the form of ether oxygen, ester oxygen, thioether sulfur or secondary or tertiary amine nitrogen, and which optionally has a silane group;
R² is a linear or branched alkylene or cycloalkylene radical having 1 to 20 carbon atoms, optionally having aromatic components, and optionally having one or more heteroatoms;
R³ is an alkyl radical having 1 to 8 carbon atoms;
R⁴ is an aliphatic or cycloaliphatic or arylaliphatic hydrocarbyl radical which has 1 to 12 carbon atoms and optionally has one or two ether oxygens;
Y is O or is S or NR⁰ where R⁰ is a hydrogen atom or is an alkyl radical which has a silane group and has 1 to 12 carbon atoms; and
n is 0 or 1 or 2.

14. The composition as claimed in claim 13, wherein it has, after curing, an elongation at break of at least 10%.

15. The composition as claimed in claim 13, wherein it is a coating in the form of a varnish or a seal.
